(19) United States
(12) Patent Application Publication
(10) Pub. No.: US 2026/0276906 A1
(43) Pub. Date: Sep. 17, 2026

(54) MULTI-CONNECTION OPTICAL FIBER ASSEMBLY

(71) Applicant: MELLANOX TECHNOLOGIES, LTD., Yokneam (IL)

(72) Inventors: Dima Denisenko, Afula (IL); Alex Kremenetsky, Kiryat Bialik (IL); Moti Cabessa, Ramat Gan (IL)

(21) Appl. No.: 19/080,306

(22) Filed: Mar. 14, 2025

(51) Int. Cl. G02B 6/40; G02B 6/38

(52) U.S. Cl. CPC G02B 6/403; G02B 6/3893

(57) ABSTRACT

An optical fiber assembly comprises a plurality of first connectors each having a first plurality of optical channels and a plurality of second connectors for connection with a Co-Packaged Optics (CPO) switch, each having a second plurality of optical channels. The first connectors are connected with the second connectors via a plurality of optical fibers, such that each first connector is connected with all of the second connectors. The optical fiber assembly includes twice as many first connectors as second connectors, and consequently each second connector includes twice as many optical fiber connections as each first connector.

### BACKGROUND

As artificial intelligence and/or machine learning use increases, the amount of information being communicated between large clusters of computing resources (e.g., graphical processing units (GPUs), central processing units (CPUs), data processing units (DPUs), and/or the like) is also increasing. Links between computing resources and/or chips thereof are based on copper cables (short reach) or optical cables. In the optical cables, the data to be transferred between chips (or switches) is encoded/decoded from electrical to optical signal (and vice versa) and conveyed via an optical fiber. For optical connections, optical switches encompass computing resources to distribute data packets among a plurality of optical channels to multiple receivers. Those optical switches may be configured to provide optical signals from a single output channel of the optical switch to multiple channels that can connect to separate external devices. However, limitations in optical cable design have limited the number of switch channels that can connect with a single external device and the types of optical fibers that can be incorporated into a single connector. Therefore, there is a need in the art for optical cable designs that enable connection between many computing resources of optical switches and many external devices, for example, between a different number of computing resources and a different number of external devices.

### GENERAL DESCRIPTION

As the number of optical connections from a computing resource of an optical switch (e.g., a CPO switchboard of a CPO switch) increases, the physical size of connectors to the computing resource becomes a limiting factor for the number of devices that can connect to a single computing resource of an optical switch. When each of those connectors must be spaced/sized to accommodate one or more adapters (e.g., to accommodate different connection types and/or different fiber types), the combined size of the connectors and adapters can severely limit the number of connections possible for a CPO switch. Conventionally, each fiber type requires a separate ferrule. The disclosure integrates multiple fiber types within the same ferrule, decreasing the number of required ferrules—and consequently, the number of optical connectors.

To address the spatial challenges that arise when connecting multiple connectors to a single CPO switch, a multi-connection optical fiber assembly comprises different connector types, fiber types, and different connector quantities in the optical fiber assembly. Each connector comprises a plurality of optical fibers that are shuffled within the assembly, such that each connector on each end are connected with all of the connectors on the other end. In one embodiment, the assembly shuffles optical fibers between m connectors for connection with a Co-Packaged Optics (CPO) switch on a first side of the assembly and 2m connectors for connection with removable, user-facing optical fibers on an opposite second side of the assembly Each of the m connectors on the first side have x optical fibers that are used for connection therein, and each of the 2m connectors on the second side have (x/2) fibers used for connection therein, so that the total number of connectors within the shuffle box can be reduced by half (thereby reducing the physical size of the shuffle box), while still accommodating the same number of optical connections as compared with optical cables having equal numbers of fibers in connectors on each end. At least two fibers in each of the m connectors (e.g., a transmit fiber and a receive fiber) connected with an external laser connector. Some connectors may have unused fiber spaces therein.

In other embodiments, the optical fiber assembly includes at least three connector types. One connector type connects to at least one of each of the other two connector types using different fiber types for each connection. Thus, a first connector type comprises at least two different fiber types (e.g., polarization maintaining fibers (PMFs) and single mode fibers (SMFs)). A first fiber type connects to a second connector type, and a second fiber type connects to a third connector type. The disclosure enables a reduction in the required number of optical connectors per system and minimizes the number of optical connectors required to shuffle SMF and PMF fibers within a system. This configuration optimizes fiber routing while maintaining system reliability. In some embodiments, both SMF and PMF fibers are combined within the same optical ferrule (e.g., MT-24), effectively reducing the number of optical connectors inside the system by half. The SMF and PMF fibers are merged into a single connector, reducing the volume and number of connectors by half making the system more compact and efficient. This solution also simplifies the design and reduces costs.

The number of SMF or PMF fibers is irrelevant; for example, even using just one SMF and one PMF in a system would require two optical connectors in the conventional approach. The overall numbers of fibers remain the same, the number of connectors reduced by half.

Certain embodiments are directed to an optical fiber assembly comprising: one or more first connectors; one or more second connectors; one or more third connectors; a plurality of first optical fibers of a first fiber type connecting the one or more first connectors to the one or more second connectors; and a plurality of second optical fibers of a second fiber type connecting the one or more second connectors with the one or more third connectors.

In certain embodiments, the plurality of first optical fibers terminate at pins in the one or more first connectors and terminate at pins in the one or more second connectors; and the plurality of second optical fibers terminate at pins in the one or more second connectors and at pins in the one or more third connectors. In various embodiments, the plurality of first optical fibers are single mode fibers (SMFs); and the plurality of second optical fibers are polarization maintaining fibers (PMFs). In various embodiments, each of the one or more second optical connectors contains a portion of each of the plurality of first optical fibers and a portion of each of the plurality of second optical fibers. In certain embodiments, the one or more first optical connectors comprises a first quantity of first optical connectors; the one or more second optical connectors comprises a second quantity of second optical connectors; and the one or more third optical connectors comprises a third quantity of third optical connectors.

Various embodiments are directed to an optical fiber assembly comprising: a plurality of first connectors each having a first plurality of optical channels; a plurality of second connectors for connection with a Co-Packaged Optics (CPO) switch, each having a second plurality of optical channels; a plurality of optical fibers each terminating in one of the plurality of first connectors and one of the plurality of second connectors; wherein each of the plurality of first connectors terminates x optical fibers in the first plurality of optical channels, wherein the x optical fibers collectively connect each of the plurality of first connectors with all of the plurality of second connectors; wherein each of the plurality of second connectors terminates at least 2x optical fibers in the second plurality of optical channels, wherein the at least 2x optical fibers collectively connect each of the plurality of second connectors with all of the plurality of first connectors.

In certain embodiments, the first plurality of optical channels is 12 optical channels; and the second plurality of optical channels is 24 optical channels. In various embodiments, x is 8 and wherein at least 2x is 18. In certain embodiments, the x optical fibers terminating in each of the plurality of first connectors are bundled in a plurality of first bundles. In certain embodiments, the 2x optical fibers terminating in each of the plurality of second connectors are bundled in a plurality of second bundles. In various embodiments, the optical fiber assembly further comprises a fanout box, and wherein optical fibers are shuffled between the plurality of first bundles on a first end of the fanout box and the plurality of second bundles on a second end of the fanout box. In certain embodiments, the optical fiber assembly comprises a plurality of external laser connectors; a plurality of tertiary optical fibers each terminating in one of the plurality of second connectors and one of the plurality of external laser connectors. In certain embodiments, each of the plurality of optical fibers are a first fiber type; and each of the plurality of tertiary optical fibers are a second fiber type. In various embodiments, each of the plurality of optical fibers are single mode fibers (SMFs); and each of the plurality of tertiary optical fibers are polarization maintaining fibers (PMFs).

Various embodiments are directed to an optical fiber assembly comprising:
a plurality of first optical cables for connection with a Co-Packaged Optics (CPO) switch; a plurality of second optical cables; a plurality of optical channels within the first optical cables and the second optical cables to optically connect the plurality of first optical cables with the plurality of second optical cables; and wherein each of the plurality of first fibers is optically connected with all of the plurality of second fibers by respective optical channels of the plurality of optical channels.

Certain embodiments are directed to an optical fiber assembly comprising: a plurality of first optical cables extending from the optical fiber assembly; and a plurality of second optical cables extending from the optical fiber assembly; wherein the optical fiber assembly optically connects the plurality of first optical cables with the plurality of second optical cables.

In various embodiments, the plurality of first fiber optical cables comprise a plurality of fibers; the plurality of second optical cables each comprise a plurality of fibers; and wherein the optical fiber assembly further comprises a fanout box shuffling the plurality of fibers from the plurality of first optical cables to the plurality of second optical cables.

In certain embodiments, the optical fiber assembly comprises twice as many second optical cables as first optical cables. In various embodiments, each of the plurality of first optical cables comprises twice as many fibers as each of the plurality of second optical cables. In various embodiments, each of the plurality of first optical cables is connected with all of the plurality of second optical cables. In certain embodiments, the first optical cables have a first connector type and the second optical fibers have a second connector type. In various embodiments, the optical fiber assembly further comprises a plurality of tertiary optical cables extending from the second connector type, wherein the plurality of tertiary optical cables comprise optical fibers of a different fiber type than the first optical cables and second optical cables.

Certain embodiments are directed to an optical shuffle box comprising: an optical fiber assembly; a housing containing the optical fiber assembly; and a plurality of external connectors connected with the first fibers, wherein the plurality of optical connectors are positioned on a front side of the housing and occupy greater than 50% of an area defined by the front side of the housing.

In certain embodiments, the plurality of external connectors are Multi-Fiber Push On (MPO) connectors. In various embodiments, the plurality of external connectors comprises 8 external connectors.

Certain embodiments are directed to a method of transmitting an optical signal, the method comprising: transmitting an optical signal into a first optical fiber in a connector comprising a first plurality of optical fibers; routing the optical signal along the first optical fiber into a second connector comprising a second plurality of optical fibers; wherein the second plurality of optical fibers is a different quantity than the first plurality of optical fibers.

### BRIEF DESCRIPTION OF THE SEVERAL VIEWS OF THE DRAWINGS

For a better understanding of embodiments of the disclosure and to show how the same may be carried into effect, reference will now be made, purely by way of example, to the accompanying drawings in which like numerals designate corresponding elements or sections throughout. In the accompanying drawings:

FIG. 1A shows an optical fiber assembly according to one embodiment;

FIG. 1B is a closeup view of first optical connectors according to one embodiment;

FIGS. 2A-2D show a first optical connector according to one embodiment;

FIGS. 3A-3E show a second optical connector according to one embodiment;

FIGS. 4A-4D show a third optical connector according to one embodiment;

FIG. 5 schematically illustrates connection shuffling according to one embodiment;

FIG. 6 shows a front panel of a cassette according to one embodiment;

FIGS. 7A-7B schematically shows connections within a cassette according to one embodiment;

FIG. 8 illustrates an example computer system that may include electrical components, according to at least one embodiment;

FIG. 9 provides a block diagram that schematically illustrates a computing system that may include one or more electrical components of various embodiments;

FIG. 10 illustrates an example computing environment that may include electrical components, in accordance with at least one embodiment;

FIG. 11 illustrates an example network switch according to at least one embodiment.

FIG. 12 shows an optical shuffle box comprising a plurality of cassettes and optical fiber assemblies for connection with a network switch according to one embodiment.

FIG. 13 schematically shows connections between a single cassette and a plurality of compute resources according to an embodiment.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

As the number of optical connections for an optical switch continues to increase, the physical size of connectors for these optical connections is continuing to become a limitation to increasing transfer speeds. Connector assemblies as discussed herein address these spatial challenges by increasing the number of optical fibers within individual connectors, and by connecting connectors of different types on opposite sides of the optical fiber assembly. The optical fibers extending between the different connector types can be shuffled, so that each connector on each end of the assembly connects to all of the connectors on the opposite end of the assembly using at least one fiber. In some embodiments, the number of connectors on one side of the assembly is greater (e.g., double) the number of connectors on the opposite side of the assembly. Some optical fiber assemblies additionally comprise fibers extending from connectors on one end to tertiary connectors (e.g., external laser source connectors).

As used herein, the term “optical cable” refers to a cable consisting of one or more optical fibers that are bundled together. The optical cable may provide the optic fibers in any geometric arrangement, including as a ribbon (e.g., with a plurality of optic fibers arranged side-by-side in one or more rows), as a grouped bundle that defines an at least substantially circular cross-section of the optical cable. In some embodiments, the individual fibers within a bundle may be individually sheathed (such that the sheaths of individual fibers are not connected with one another), and the plurality of sheathed fibers may be provided within a single jacket. In some embodiments, the jacket and sheath may be integrated, such as for a ribbon cable in which the integrated jacket and sheath serve to sheath individual fibers and to maintain a desired flat arrangement of the fibers relative to one another. The jacket and sheaths can be flexible, so that the resulting optical cable is flexible. As an example, the jacket and sheaths may be flexible polymers. However, it should be understood that other jacket and sheath configurations may be utilized.

Silicon Photonics (SiP) is a technology that enables optical systems to be manufactured using silicon processes with silicon as the optical medium. Various optical components, such as interconnects and signal processing components, may be fabricated and integrated in a single SiP device. Some SiP devices are fabricated on a silica substrate or over a silica layer on a silicon substrate, a technology that is often referred to as Silicon on Insulator (SOI). In certain optical systems, a SiP device is attached to an external device to facilitate optical communications. However, it is generally difficult to accurately align light signals on the SiP with an external device that receives the light. In certain optical systems, a SiP device is attached to an external device to facilitate optical communications. However, it is generally difficult to accurately align light signals on the SiP with an external device that receives the light. For instance, long range transmission of light signals is generally performed within optical fibers. When optical signals are generated or processed in a SiP device for transmission over optical fibers, the light needs to be coupled between the SiP device and the optical fibers. This coupling between the SiP device and the optical fibers is generally difficult because waveguides within the SiP device generally have a smaller diameter than the optical fibers. As such, a “world-to-chip” interface problem often arises in SiP technologies where coupling of light between Si wire waveguides and optical fibers, and vice versa, is generally inefficient.

“Co-packaging” may refer to the close integration of different electrical and/or optoelectronic chips in the same package.

As discussed herein, optical fiber assemblies 100 may comprise multiple fibers of different fiber types. As examples of different fiber types, a fiber may be a Single Mode Fiber (SMF). The SMF comprises a single core surrounded by a cladding layer. A second fiber type may be a Polarization Maintaining Fiber (PMF) comprising a single core having two stress rods on opposite sides of the core. The core and stress rods are surrounded by a cladding layer. In the example, the stress rods are shown with a circular cross-section, although other stress rod shapes (e.g., bow-tie shaped) may be provided for certain embodiments. As the terms are used herein, it should be understood that SMFs do not contain stress rods, while PMFs contain stress rods. Certain embodiments may comprise other fiber types, in place of, or in addition to SMF and/or PMF fibers. For example, certain embodiments may comprise multi-mode fibers (MMF) within a connector comprising at least one other fiber type.

### Optical Fiber Assembly

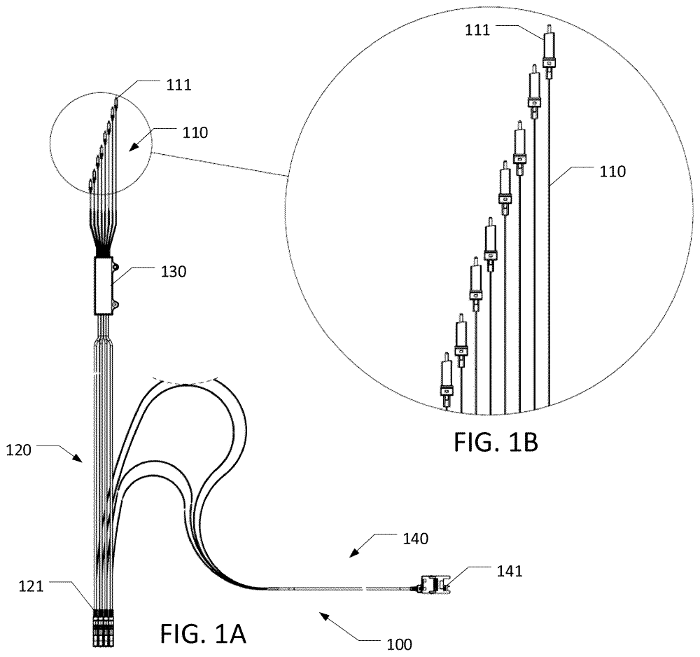

FIG. 1A shows an optical fiber assembly 100 according to some embodiments. As shown, the optical fiber assembly comprises a plurality of first optical cables 110 each having a first optical connector 111 and a plurality of second optical cables 120 each having a second optical connector 121. The quantity of first optical cables 110 is different from the quantity of second optical cables 120. In the illustrated example, the quantity of first optical cables 110 is double the quantity of second optical cables 120. It should be understood that the quantity of first optical cables 110 may be greater or less than the quantity of second optical cables 120.

Each of the first optical connectors 111 and second optical connectors 121 comprise a plurality of optical pins 113, 123, 124. Each optical pin 113, 123, 124 is for terminating a single optical fiber of the optical cable 110, 120 and for conveying optic signals from the corresponding optical fibers to/from external devices or connectors. In the illustrated embodiment, the first optical connectors 111 each comprise x optical pins 113, and the second optical connectors each comprise y optical pins 123, 124. In other words, the second optical connectors 121 comprise a different quantity of optical pins as the first optical connectors 111. In the specifically illustrated embodiment, y=2x, so that each second optical connector 121 comprises double the quantity of optical pins as each first optical connector 111.

As shown, the first optical cables 110 are connected with the second optical cables 120 at a fanout box 130. The first optical cables 110 and second optical cables 120 comprise the same fiber type (as discussed herein, the optical fibers extend from inside the first optical cables 110 to inside the second optical cables 120). For example, the fibers within the first optical cables 110 and the second optical cables 120 may be SMFs. Moreover, the optical fiber assembly 100 additionally comprises tertiary optical cables 140 connected to a third optical connector 141 and connected to each of the second optical connectors 121. The tertiary optical cables 140 may comprise optical fibers of a second fiber type, such as PMF fibers. In the illustrated embodiments, each third optical connector 141 comprises z optical cables, wherein z is different from y. In the specifically illustrated example, y=2z=2x, so that each second optical connector 121 comprises double the quantity of optical pins as each third optical connector 141 (and first optical connector 111).

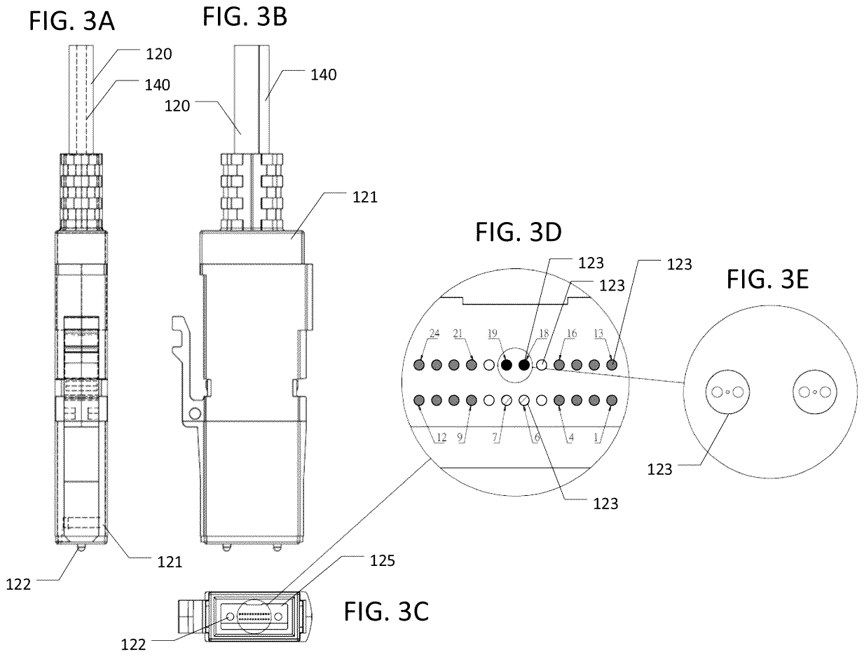

As shown, the second optical connectors 121 comprise pins for fibers of the first fiber type and pins for fibers of the second fiber type. As a specific example, each of the second optical connectors 121 may comprise a plurality of SMF fibers terminating in pins in the second optical connector 121 and a plurality of PMF fibers terminating in pins in the third optical connector 141, as shown in the example of FIGS. 3D-3E.

Each of the first optical cables 110 and each of the second optical cables 120 are jacketed to group the contained optical fibers therein. The first optical cables 110 each comprise a first quantity of optical fibers and the second optical cables 120 each comprise a second quantity of optical fibers. As a non-limiting example, one of the first optical cables 110 may comprise 12 optical fibers (all of the first optical cables 110 may have an identical number of optical fibers contained therein). As a second non-limiting example, one of the second optical cables 120 may comprise 24 optical fibers (all of the second optical cables 120 may have an identical number of optical fibers contained therein). It should be understood that the first optical cable 110 and second optical cable 120 may comprise different numbers of optical fibers.

FIG. 1B shows a close-up view of the first optical cables 110 and first optical connectors 111. As shown, the first optical cables 110 may have different lengths. As discussed in more detail herein, the fanout box 130 and first optical cables 110 may be installed inside a cassette 150 and the first optical cables 110 may extend to secure the first optical connectors 111 to external connectors (e.g., input/output (I/O) connectors) 155 arranged in a line in the cassette 150. The external connectors 155 may be spaced progressively farther away from a first end of the fanout box 130, and so the different lengths of first optical cables 110 accommodate the different distances between the first end of the fanout box 130 and the positions of the external connectors 155.

In the embodiment of FIG. 1A, the optical fiber assembly 100 comprises a fanout box 130 between the first optical cables 110 and the second optical cables 120. In the illustrated embodiment, the fanout box 130 is a rigid box having a lid that can be opened to expose a hollow interior of the fanout box 130. The fanout box 130 defines a first end having one or more apertures and a second end having one or more apertures. The plurality of first optical cables 110 are connected to the fanout box 130 at the apertures of the first end and the plurality of second optical cables 120 are connected to the fanout box 130 at the apertures of the second end. The fanout box 130 provides a protective enclosure for optical fibers (e.g., of a first fiber type) extending from the first optical cables 110 to the second optical cables 120. In some embodiments, the jacketing of the first optical cables 110 and second optical cables 120 terminate at the respective apertures of the fanout box 130, so that the individual optical fibers are exposed (within their respective sheaths) inside the fanout box 130. The optical fibers are “shuffled” inside the fanout box 130 to connect each of the first optical cables 110 with a plurality of second optical cables 120, and vice versa. In the illustrated embodiment, each first optical cable 110 is connected with every second optical cable 120 by one or more fibers, and each second optical cable 120 is connected with every first optical cable 110 by one or more fibers. In some embodiments, each first optical cable 110 is connected with every second optical cable 120 by two or more optical fibers (for transmission and reception, respectively); and similarly, each second optical cable 120 is connected with every first optical cable 110 by two or more optical fibers (for transmission and reception, respectively). As shown in FIG. 1A, the fanout box 130 may define one or more mounting holes to accept a fastener (e.g., a screw) therein to secure the fanout box 130 to a support surface, such as the interior of a cassette 150, as discussed in greater detail herein.

Each optical fiber that passes through the fanout box 130 is contained in one of the first optical cables 110 and one of the second optical cables 120. Said differently, a single optical fiber extends from a pin 113 of a first connector 111 of a first optical cable 110, through the jacketing of the first optical cable 110, through the fanout box 130, through the jacketing of a second optical cable 120, and to a pin 123 of a second connector 121 of the second optical cable 120. Thus, each optic fiber terminates on a first end in a first connector 111 of a first optical cable 110 and terminates on a second end in a second connector 121 of a second optical cable 120. Moreover, all of the optical fibers that pass through the fanout box 130 from the first optical cables 110 to the second optical cables 120 are of the same fiber type (e.g., SMFs).

As discussed above, the total number of first optical cables 110 differs from the total number of second optical cables 120. In such embodiments, the number of optical fibers in each first optical cable 110 differs from the number of optical fibers in each second optical cable 120. This arrangement enables each first optical cable 110 to be connected with all of the second optical cables 120, and vice versa. For example, the optical fiber assembly 100 comprises twice the number of first optical cables 110 as second optical cables 120, and the second optical cables 120 comprise twice the number of optical fibers as the first optical cables 110. In the illustrated embodiment of FIG. 1A, the optical fiber assembly 100 comprises 8 first optical cables 110 and 4 second optical cables 120.

In some embodiments, the number of optical pins 113 in each first optical connector 111 need not match the number of optical fibers in the first optical cables 110 and/or every optical pin 113 in each first optical connector 111 need not be connected with every optical fiber in the first optical cable 110. The number of optical pins 113 in each first optical connector 111 can match or exceed the number of optical fibers in the first optical cables 110. If the number of optical pins 113 exceeds the number of optical fibers in the first optical cables 110, a subset of optical pins 113 within each first optical connector 111 are unused or may terminate optical fibers that are not contained within the first optical cables 110, as they do not terminate a corresponding optical fiber contained in the first optical cables 110. In some embodiments, the first optical connector 111 may contain multiple fiber types (e.g., one or more SMFs and one or more PMFs). The same configuration can apply to the second optical connectors 121. Specifically, the number of optical pins 123 in each second optical connector 121 need not match the number of optical fibers in the second optical cables 120 and/or the every optical pin 123 in the second optical connectors 121 need not be connected with every optical fiber in the second optical cables 120. The number of optical pins 123 in each second optical connector 121 can match or exceed the number of optical fibers in the second optical cables 120. If the number of optical pins 123 exceeds the number of optical fibers in the second optical cables 120, a subset of optical pins 123 within each second optical connector 121 are unused or may terminate optical fibers that are not contained within the second optical cables 120, as they do not terminate a corresponding optical fiber contained within the second optical cables 120. It should be understood that when comparing the number of optical pins in a connector against the number of optical fibers within a corresponding optical cable, the comparison can be between the number of optical pins against the number of utilized optical fibers. In other words, an optical cable may comprise one or more unused optical fibers (i.e., that are not terminated at pins of the corresponding optical connector); these unused optical fibers are not counted when comparing the number of optical pins of a connector against the number of optical fibers in a corresponding optical cable.

As shown in FIG. 1A, one or more third optical connectors 141 are connected to the plurality of second optical connectors 121 by one or more optical fibers in a tertiary optical cable 120. All of the optical fibers in the tertiary optical cable 120 may be the same fiber type (e.g., PMF), and are of a fiber type that is different from the first optical cable 110 and second optical cable 120. Specifically, a plurality of optical fibers may terminate in a single third optical connector 141, and the plurality of these optical fibers includes one or more optical fibers terminating in each of the second optical connectors 121. Even more specifically, two of these optical fibers may terminate on one end at optical pins 123 in each second optical connector 121 (for transmitting and receiving, respectively) and all of these optical fibers may terminate on an opposite end at optical pins 143 in a single third optical connector 141. The fibers terminating in each of the second optical connectors 121 terminate at pins 123 that are not used to connect with optical fibers extending to the first optical connectors 111.

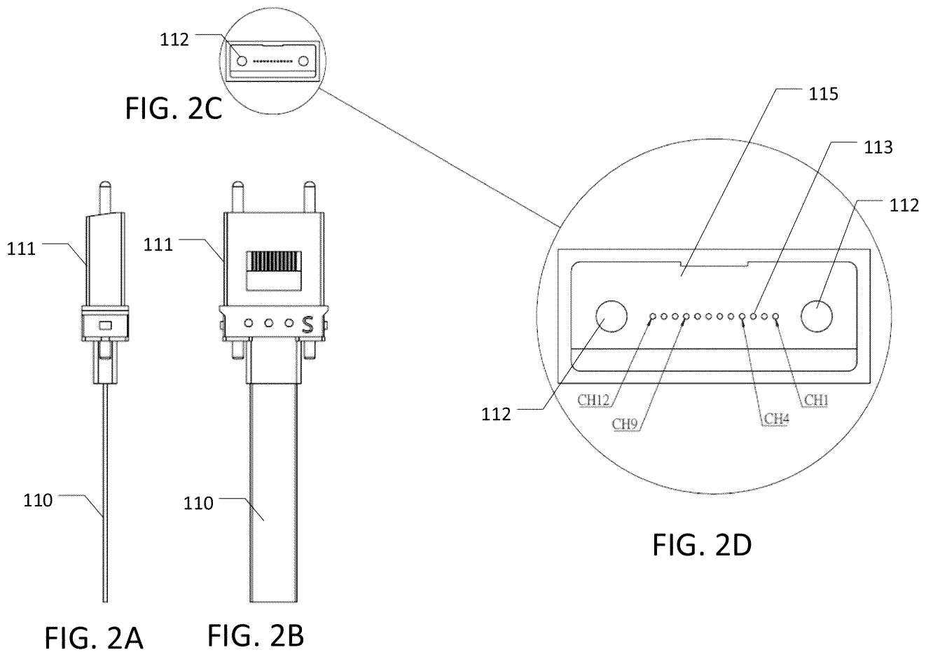

FIGS. 2A-2D illustrate an example first optical connector 111 according to one embodiment. As shown, the first optical connector 111 terminates a first optical cable 110, and comprises a plurality of optical pins 123, each optical pin 123 defining a channel, and terminating a single corresponding optical fiber from the first optical cable 110. The optical fibers terminating in the illustrated first optical connector 111 are of the same fiber type (e.g., SMF).

Moreover, the illustrated first optical connector 111 has a housing for securing the first optical cable 110 therein and for connecting the first optical connector 111 to another mating connector (not shown). At a distal end of the housing (opposite the first optical cable 110), the first optical connector 111 includes two alignment pins 112 extending out of the connector in the same direction as the optical pins 113. The alignment pins 112 extend out of the connector 111 by a distance greater than the optical pins 113. In the illustrated embodiment, the optical pins 113 are within a depression 115 in a distal end of the connector 111 and the alignment pins 112 extend out of the depression 115. While the embodiment of FIGS. 2A-2D include 2 alignment pins, it should be understood that other numbers of alignment pins 112 may be used in other embodiments.

In the illustrated embodiment, the optical pins 113 are labeled with a channel number. Each optical pin 113 has a corresponding channel (although only some of the pins are labeled to avoid overcrowding the figure). As shown, the channels are numbered consecutively from CH1 (channel 1) to CH12 (channel 12). Every optical pin 113 may have a corresponding optical fiber terminating thereat, so that all optical pins 113 are used. However, in some embodiments, some optical pins 113 may be unused, and/or some optical pins 113 may terminate optical fibers that are not part of the first optical cable 110. In one example, the first optical connector 111 is a multifiber (MT) connector.

FIGS. 3A-3E illustrate an example second optical connector 121 according to one embodiment. In the illustrated embodiment, the second optical connector 121 terminates a second optical cable 120 and a tertiary optical cable 140 having optical fibers that connect with a third optical connector 141 as discussed herein. The tertiary optical cable 140 may be attached to the second optical cable 120 along a portion of the length of the second optical cable 120 and the tertiary optical cable 140.

In the embodiment of FIGS. 3A-3E, the second optical connector 121 comprises a plurality of optical pins 123, each optical pin 123 defining a channel, and terminating a single corresponding optical fiber from the second optical cable 120 or the tertiary optical cable 140. As discussed herein, the optical fibers of the second optical cable 120 are a different fiber type than the optical fibers of the tertiary optical cable 140 in the illustrated embodiment. As reflected in the close-up view of FIG. 3E, the fibers of the second optical cable 120 are SMFs and the fibers of the tertiary optical cable 140 are PMFs (FIG. 3E).

Moreover, the illustrated second connector has a housing for securing the second optical cable 120 and tertiary optical cable 140 therein and for connecting the second optical connector 121 to another mating connector (not shown). At a distal end of the housing (opposite the second optical cable 120 and tertiary optical cable 140), the second optical connector 121 includes two alignment pins 122 extending out of the connector in the same direction as the optical pins 123, 124. The alignment pins 122 extend out of the connector 121 by a distance greater than the optical pins 123, 124. In the illustrated embodiment, the optical pins 123, 124 are within a depression 125 in a distal end of the connector 121 and the alignment pins 122 extend out of the depression 125. While the embodiment of FIGS. 3A-3E include 2 alignment pins 122, it should be understood that other numbers of alignment pins may be used in other embodiments.

As shown, the housing includes a deformable clip for attaching the second optical connector 121 to mating connectors.

In the close-up view of FIG. 3D, the optical pins 123, 124 are labeled with a channel number. Each optical pin 123, 124 has a corresponding channel (although only some of the pins are labeled to avoid overcrowding the figure). As shown, the channels are numbered consecutively from channel 1 to channel 24. Every optical pin may have a corresponding optical fiber terminating thereat, so that all optical pins are used. However, in some embodiments, some optical pins may be unused. In the illustrated example, the optical pins are coded with different shading depending on their use: channels 1-4, 9-16, and 21-24 (grey) are used to connect with fibers in the second optical cable 120, channels 6-7 (cross-hatched) may be duplicate connections to one of the first optical connectors 111, and channels 18-19 (black) are connected with fibers in the tertiary optical cable 140. Channels 5, 8, 17 and 20 (white) are unused.

FIG. 3E is a close-up of two optical pins 124 in channels 18-19 for corresponding optical fibers of the tertiary optical cable 140. As shown, the optical pins 124 (and corresponding optical fibers) are PMFs having a single core and at least two stress rods positioned parallel to the single core.

In the illustrated embodiment, at least channels 1-4, 6-7, 9-16, and 21-24 are of the same fiber type and have the same configuration. Although channels 5, 8, 17, and 20 are shown as unused, these channels may have the same fiber type (but may not be connected with a first optical connector 111). The optical fibers are SMFs having a single core, without stress rods. Accordingly, the second optical connector 121 comprises at least two different fiber types terminating at optical pins 123-124. In one example embodiment, the second optical connector 121 is an MXC connector with multiple fiber types terminating therein.

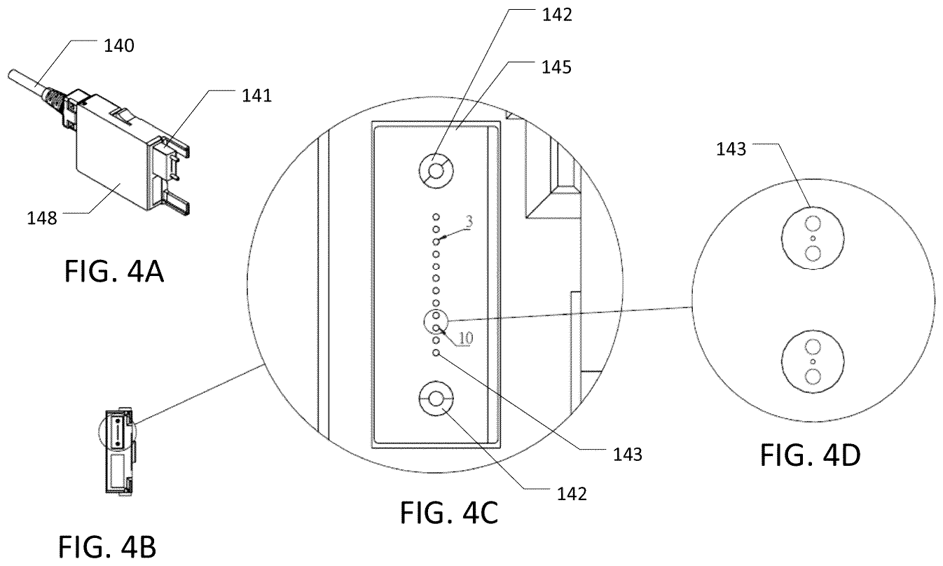

FIGS. 4A-4D illustrate an example third optical connector 141 according to one embodiment. In the illustrated embodiment, the third optical connector 141 terminates a tertiary optical cable 140 and comprises a plurality of optical pins 144, each optical pin 144 defining a channel, and terminating a single corresponding optical fiber from the tertiary optical cable 140. Moreover, the illustrated third optical connector 141 includes two alignment pins 142 extending out of the connector in the same direction as the optical pins 144. The alignment pins 142 extend out of the connector by a distance greater than the optical pins 144. In the illustrated embodiment, the optical pins 144 are within a depression 145 in a distal end of the connector and the alignment pins 142 extend out of the depression 145. While the embodiment of FIGS. 4A-4D include 2 alignment pins, it should be understood that other numbers of alignment pins may be used in other embodiments.

In the illustrated embodiment, the optical pins 144 are labeled with a channel number. Each optical pin 144 has a corresponding channel (although only some of the pins are labeled to avoid overcrowding the figure). As shown, the channels are numbered consecutively from channel 1 to channel 12. Every optical pin may have a corresponding optical fiber terminating thereat, so that all optical pins are used. However, in some embodiments, some optical pins may be unused, and/or some optical pins may terminate optical fibers that are not part of the tertiary optical cable.

As shown in FIG. 4D, the optical pins 144 terminate PMFs that connect with the second optical connector 121. All of the optical pins 144 terminate fibers of the same fiber type. As discussed herein, the optical pins 144 include pairs of pins terminating PMF fibers that extend to each of the plurality of second optical connectors 121, so that every one of the second optical connectors 121 is connected with the third optical connector 141 by a separate pair of PMFs.

In the illustrated embodiment, the third optical connector 141 is secured within a connector body 148 configured to mechanically fasten two third optical connectors 141 adjacent to one another. Only a single third optical connector 141 is illustrated in the connector body 148 in FIGS. 4A-4B.

As a non-limiting example, the third optical connector 141 is an external laser small form factor pluggable (ELSFP) connector.

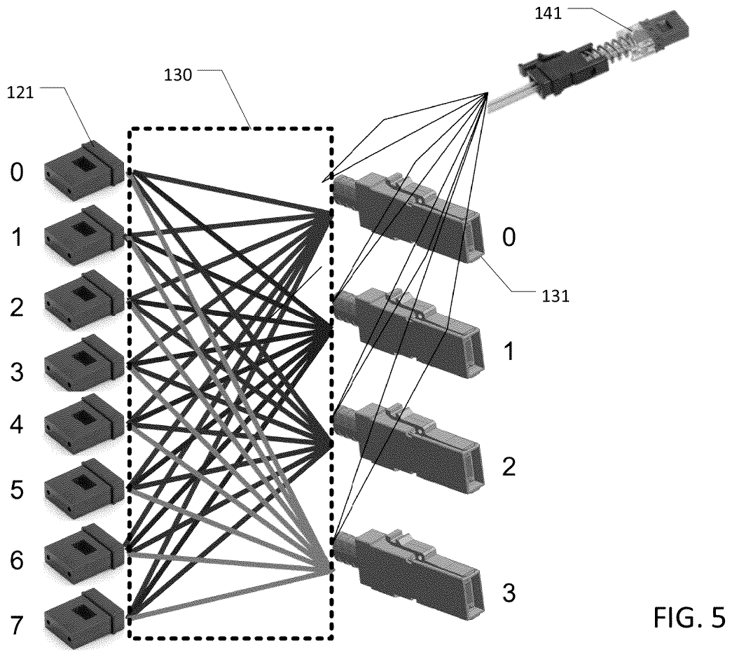

FIG. 5 schematically illustrates the fiber shuffling among the first optical connectors 111 (and first optical cables 110), the second optical connectors 121 (and second optical cables 120), and the third optical connectors 141 (and tertiary optical cables 140). As shown schematically by the dashed box, the fiber shuffling occurs within the fanout box 130. In the illustrated embodiment of FIG. 5, the optical fiber assembly 100 comprises 8 first optical connectors 111 (first connectors 0-7), 4 second optical connectors 121 (second connectors 0-3), and one third optical connector 141 (third connector ELSPF). As shown in FIG. 5, first optical connector 0 is connected with all of second optical connectors 0-3. First optical connectors 1-7 are likewise each connected with all of second optical connectors 0-3. Similarly, second optical connector 0 is connected with all of first optical connectors 0-7. Third optical connector 141 is connected with all of second optical connectors 0-3 with two optical fibers within tertiary optical cables.

More specifically, optical fibers extend from channels in first optical connector 0 to channels in all of second optical connectors 0-3. Likewise, optical fibers extend from channels in each of first optical connectors 1-7 to channels in all of second optical connectors 0-3. In some embodiments, two optical fibers extend from two channels in first optical connector 0 to two channels in all of second optical connectors 0-3. In other embodiments, four optical fibers extend from four channels in first optical connector 0 to second optical connectors 0-1 and two optical fibers extend from two channels in first optical connector 0 to second optical connectors 2-3. In other words, each first optical connector need not use the same number of channels for connecting to each of the second connectors. In some embodiments, where four (or more) channels extend from the first optical connector to a second optical connector, a subset of the fibers may serve as an optical loopback to enable verification of the optical path without powering on an optical device connected with the connectors.

### Casssette

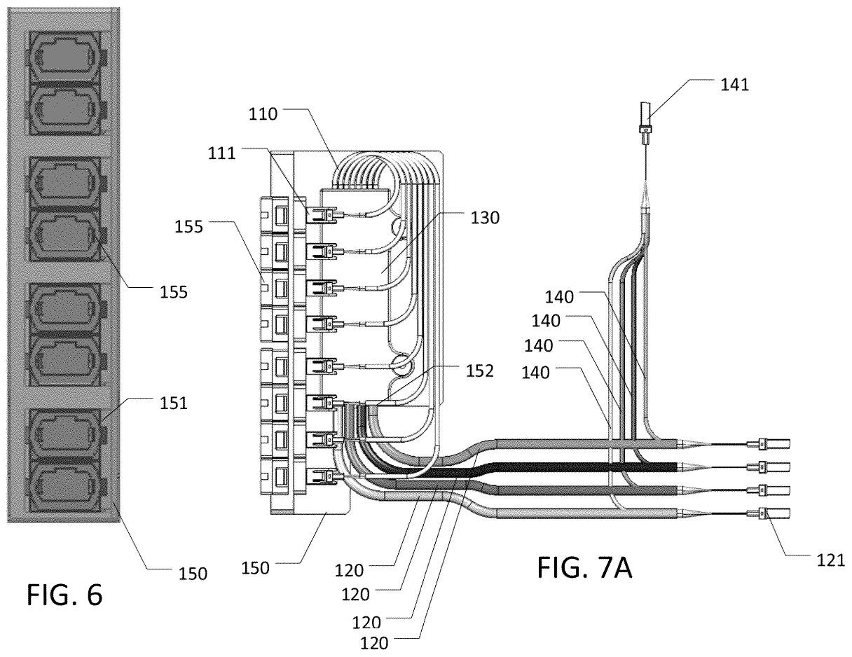

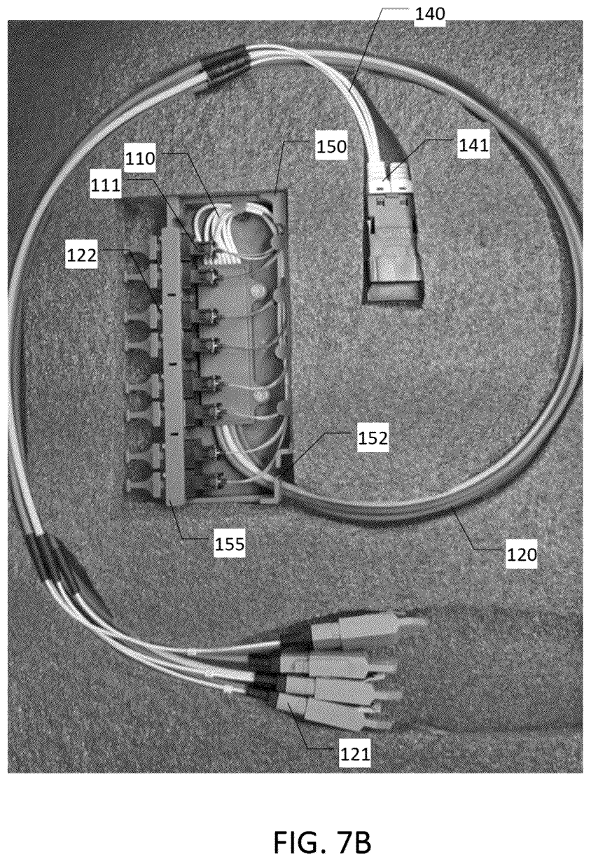

In some embodiments, the optical fiber assembly 100 is partially housed within a cassette 150, as shown schematically in FIGS. 6 and 7. The cassette 150 comprises a rigid housing that provides electromagnetic shielding. The cassette 150 comprises a housing defining a front panel, as shown in FIG. 6. The front panel defines one or more apertures 151 for securing external connectors 155 (e.g., multi-fiber push on (MPO) connectors) within the apertures 151 such that a front surface of each of the external connectors 155 define a portion of the front panel of the cassette 150. The cassette is a compact apparatus, and in some embodiments, greater than 40% of an area defined inside the perimeter of the front panel is occupied by the external connectors 155. In the illustrated embodiment of FIG. 6, greater than 50% of an area defined inside the perimeter of the front panel is occupied by the external connectors 155. It should be understood that in other embodiments, greater than 55%, greater than 60%, greater than 65%, or greater than 70% of the area defined inside the perimeter of the front panel is occupied by the external connectors 155. In some embodiments, as shown in FIG. 6, a single aperture 151 may house multiple (e.g., 2) external connectors 155 therein. In some embodiments, a single aperture 151 may occupy greater than 10% of an area defined inside the perimeter of the front panel is occupied by the external connectors 155. In the illustrated embodiment of FIG. 6, a single aperture 151 may occupy greater than 12% of an area defined inside the perimeter of the front panel is occupied by the external connectors 155.

As shown in the side, partial cutaway view of the cassette 150 shown in FIG. 7A and the image of FIG. 7B, the first optical cables 110, first optical connectors 111 and fanout box 130 are housed within an interior of the cassette 150. Specifically, the first optical connectors 111 connect to mating connectors on a backside of the external connectors 155. The backside of the cassette 150 defines an opening 152 through which the second optical cables 120 exit the cassette 150. The second optical cables 120 (and tertiary optical cables 140) extend to separate mating connectors. For example, the tertiary optical cables 140 extend to external laser source connectors mounted on a substrate and the second optical cables 120 extend to connectors communicating with processing units of a co-packaged optics (CPO) switch on a separately packaged substrate.

### Signal Communication

The optical fiber assembly 100 is configured for communicating optical signals between devices connected with the connectors 111, 121, 141 of the optical fiber assembly 100. As an example method of transmitting optical signals, an external laser connected with third optical connector 141 may transmit one or more signals to one or more processing units connected to one or more of the second optical connectors 121. The external laser signals may be transmitted on PMFs that define select channels of the third optical connector 141 to communicate along the PMFs with only one of the second optical connectors 121 (and consequently, only one processing unit connected to the selected second optical connectors 121). The processing unit connected with the selected second optical connector 121 can also transmit signals back to the external laser source by routing a signal along at least one PMF in the tertiary optical cable 140 connecting the second optical connector 121 to the third optical connector 141. Moreover, the processing unit can also communicate with one or more of the first optical connectors 111 connected to the selected second optical connector 121 by communicating along one or more SMFs connected with the second optical connector 121. By communicating on a selected channel within the second optical connector 121, the processing unit can route signals to communicate with only one of the plurality of first optical connectors 111. The selected second optical connector 121 comprises at least one channel for communicating with each of the first optical connectors 111, and so the processing unit can select a particular channel corresponding to the desired receiver first optical connector 111. In some embodiments, the selected second optical connector 121 includes 2 channels corresponding to each first optical connector 111 (one channel for transmitting and one channel for receiving), and so the processing unit connected with the selected second optical connector 121 can also receive signals from one or more of the first optical connectors 111.

### Example Systems Including Optical Fiber Assemblies

In various embodiments, optical fiber assemblies 100 are incorporated into various systems. For example, various optical fiber assemblies 100 may be incorporated into datacenters, CPO switches, processing units, ICs, systems on and/or including PCBs, optical interconnects, and/or the like. Some example systems that may include optical fiber assemblies 100 of various embodiments are now described.

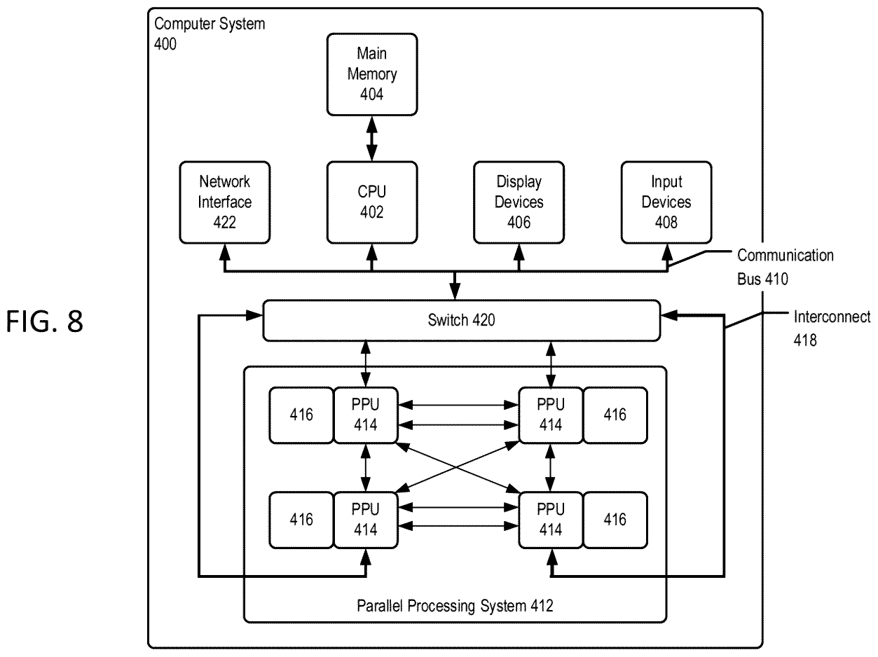

FIG. 8 illustrates a computer system 400, according to at least one embodiment. In at least one embodiment, computer system 400 is configured to implement various processes and methods described throughout this disclosure.

In at least one embodiment, computer system 400 comprises, without limitation, at least one central processing unit (“CPU”) 402 that is connected to a communication bus 410 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 400 includes, without limitation, a main memory 404 and control logic (e.g., implemented as hardware, software, or a combination thereof) and data are stored in main memory 404 which may take form of random access memory (“RAM”). In at least one embodiment, a network interface subsystem (“network interface”) 422 provides an interface to other computing devices and networks for receiving data from and transmitting data to other systems from computer system 400.

In at least one embodiment, computer system 400, in at least one embodiment, includes, without limitation, input devices 408, parallel processing system 412, and display devices 406 which can be implemented using a conventional cathode ray tube (“CRT”), liquid crystal display (“LCD”), light emitting diode (“LED”), plasma display, or other suitable display technologies. In at least one embodiment, user input is received from input devices 408 such as keyboard, mouse, touchpad, microphone, and more. In at least one embodiment, each of foregoing modules can be situated on a single semiconductor platform to form a processing system.

In at least one embodiment, computer programs in form of machine-readable executable code or computer control logic algorithms are stored in main memory 404 and/or secondary storage. Computer programs, if executed by one or more processors, enable system 400 to perform various functions in accordance with at least one embodiment. memory 404, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 402; parallel processing system 412; an integrated circuit capable of at least a portion of capabilities of both CPU 402; parallel processing system 412; a chipset (e.g., a group of integrated circuits designed to work and sold as a unit for performing related functions, etc.); and any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, computer system 400 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 412 includes, without limitation, a plurality of parallel processing units (“PPUs”) 414 and associated memories 416. In at least one embodiment, PPUs 414 are connected to a host processor or other peripheral devices via an interconnect 418 and a switch 420 or multiplexer. In at least one embodiment, parallel processing system 412 distributes computational tasks across PPUs 414 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 414, although such shared memory may incur performance penalties relative to use of local memory and registers resident to a PPU 414. In at least one embodiment, operation of PPUs 414 is synchronized through use of a command such as_syncthreads( ), wherein all threads in a block (e.g., executed across multiple PPUs 414) to reach a certain point of execution of code before proceeding.

The switches within each layer (e.g., edge layer, aggregation layer, core layer) may be 1U switches, where “1U” refers to the industry-standard size for rack-mounted switches and servers. The switches may be electrical switches, optical switches, hybrid electro-optical switches, or any combination thereof. The switches may be implemented with suitable hardware and/or software that enables the routing of signals in the appropriate domain. For example, an electrical switch may include receivers that receive and convert optical signals into electrical signals for routing within the electrical switch. A receiver of an electrical switch may include a transimpedance amplifier (TIA), a photodetector, and a controller which all serve to convert the optical signals into electrical signals. Each electrical switch may further include transmitters that convert electrical signals routed within the electrical switch into optical signals for output to another switch (optical or electrical) within the system. For example, a transmitter of an electrical switch may include a light source, a modulator, and a controller that controls the modulator and light source. In some embodiments, receiver/transmitter pairs may be integrated into a single transceiver. Each electrical switch may also include internal switching circuitry for routing electrical signals within the electrical switch.

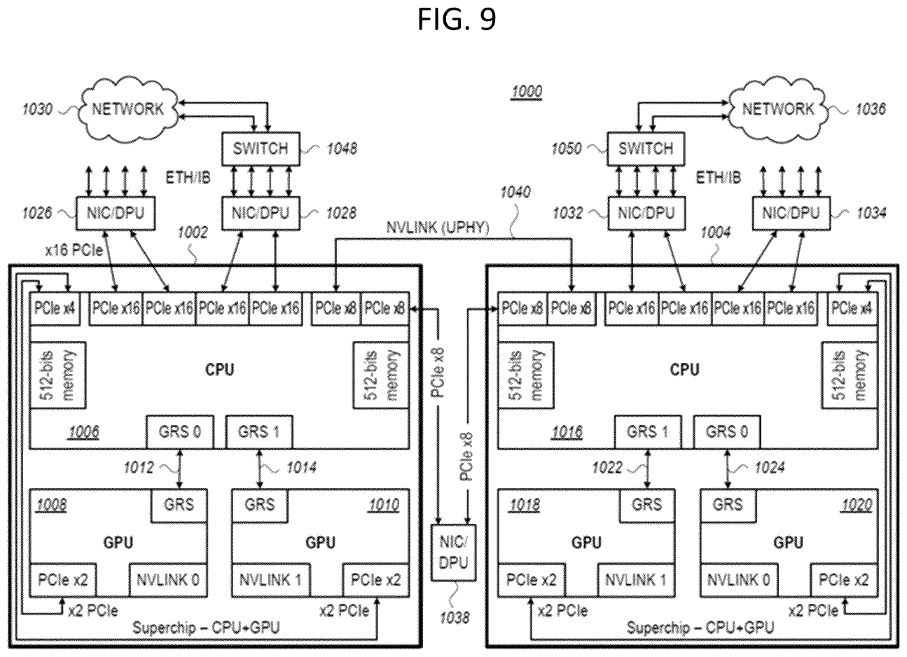

FIG. 9 is a block diagram that schematically illustrates a computing system 1000, e.g., a data center or a High-Performance Computing (HPC) cluster, in accordance with an embodiment that is described herein. System 1000 comprises a plurality of subsystems, e.g. multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036. In the present example, system 1000 comprises a packet switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more network interface controllers (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 9 also demonstrates an example architecture of a multi-GPU architecture. As illustrated in the figure, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 9, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 can be coupled to network 1030 over Ethernet (ETH), NVLINK or InfiniBand (IB) connections, for example.

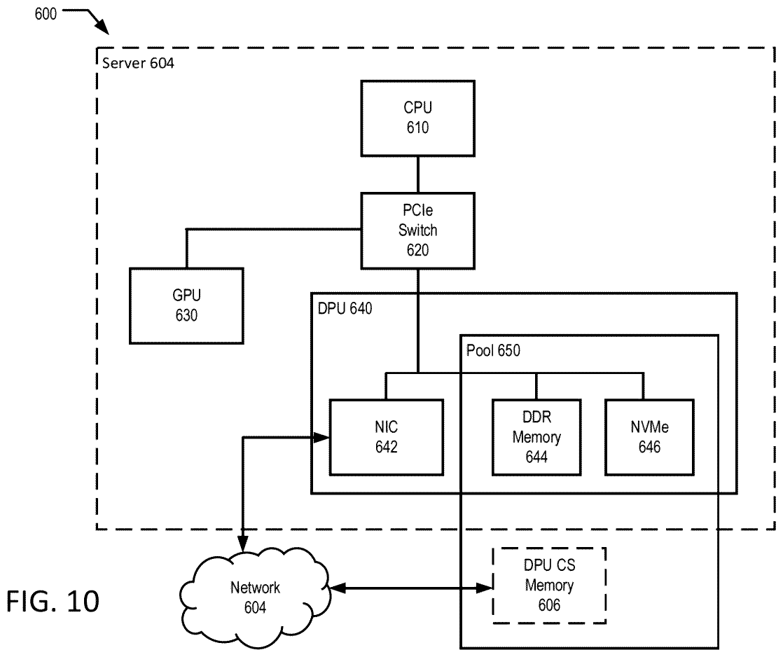

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via an D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 10, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communication with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects. The packet switches in FIG. 9 may comprise, for example, Nvidia Quantum-2 switches. The NICs/DPUs in the figure may comprise, for example, Nvidia Bluefield DPUs.

In various embodiments, any of the network devices of system 1000, e.g., any of NICs/DPUs 1026, 1028, 1032, 1034, and 1038, and/or any of switches 1048 and 1050, may include electrical components in accordance with various embodiments.

FIG. 10 illustrates an example computing environment 600 in which forward pass offloading to available memory can be performed, in accordance with at least one embodiment. It should be appreciated that embodiments of the present disclosure may also be used with reference to alternative environments and that specific discussion of components may be provided by way of non-limiting example and may include equivalents. Moreover, various features have been removed for clarity and conciseness. Additionally, systems and methods may be used with a variety of different architectures. The example computing environment 600 may include a server 602 which may be used to perform HPC workloads, such as AI training or machine learning model training. In an embodiment, the server 602 may be an application instance or a compute node. The server 602 may include a CPU 610 associated with a switch 620, such as a peripheral component interconnect express (PCIe) switch, which may control at least some data transmission over communication paths interconnecting various components. In an embodiment, the CPU 610 may include a root complex processor.

The PCIe switch 620 may also be associated with a GPU 630 and a DPU 640, and may transmit data between at least some of the CPU 610, the GPU 630, the DPU 640, and other components. In an embodiment, the PCIe switch 620 may be associated with more than one GPU or more than one DPU. In another embodiment, the PCIe switch 620 may be located within the DPU 640. The PCIe switch 620 may manage the transfer of at least some data between the CPU 610, the GPU 630, and the DPU 640. In another embodiment, the number of GPUs associated with the PCIe switch 620 may be equal to the number of DPUs associated with the PCIe switch 620. In at least one embodiment, the server 602 may include, without limitation, any number of the CPUs 610, the PCIe switches 620, the GPUs 630, and/or the DPUs 640, in any combination. For example, in at least one embodiment, server 602 could include eight, sixteen, thirty-two, and/or more GPUs 630. In at least one embodiment, communication paths interconnecting various components, including but not limited to the CPU 610, the PCIe switch 620, the GPU 630, and the DPU 640, in FIG. 10 may be implemented using any suitable protocols, such as peripheral component interconnect (PCI) based protocols (e.g., PCIe), or other bus or point-to-point communication interfaces and/or protocol(s), such as NV-Link high-speed interconnect, or interconnect protocols.

The DPU 640 may include a network interface controller (NIC) 642, a DDR memory 644, and a non-volatile memory express (NVMe) device 646. The NIC 642 may be able to interface with a network 604, which may also interface with additional NVMe devices available to the DPU 640, such as over fabric. In an embodiment, the DPU 640 may not include the NVMe device 646. In another embodiment, the NVMe device 646 may be located on the server 602 and not on the DPU 640. In yet another embodiment, the computing environment 600 may include more than one of the NVMe device 646, such as a first NVMe device in the DPU 640 and a second first NVMe device on the server 602 an associated directly with the PCIe switch 620. In an embodiment, the DPU 640 may not include the DDR memory 644 and may include a computational storage services (CSS) in place of, or in addition to, the DDR memory 644. For example, computing environment 600 may include DPU computational storage (CS) memory 606 available to the DPU 640 as part of the CSS. The network 604 may be able to interface with the DPU CS memory 606 through the NIC 642, according to any suitable interface protocol, such as remote direct memory access (RDMA) over Ethernet, InfiniBand, Fiber Channel, etc.

The total memory of the computing environment 600 available for data storage may be expanded through the use of the DPU 640 on nodes of the system. The DPU 640 may have access to a pool 650 of memory already available to the server 602, such as double data rate (DDR) memory, on-board NVMe devices, NVMe devices over fabric, and CS. The pool 650 of memory may include at least one of the DDR memory 644, NVMe device 646, and the DPU CS memory 606. The DPU 640 may also be able to access the available memory of other DPUs as part of the pool 650, and other DPUs may be able to access the available memory of DPU 640, such as the pool 650. This available memory can be accessed and utilized for data storage, without the addition of compute resources, such as compute nodes, which would be required using other solutions. The available pool 650 accessible to the DPU 640 may be provisioned for the server 602 to expand the total memory available for data storage, such as to reduce the data storage load on the CPU 610 or the GPU 630, which can instead increase the utilization of their memory for processing. For example, during training of an AI, the model states, residual states, activation functions, and checkpoints can be stored, or offloaded, on the pool 650 accessible to the DPU 640.

### Multichip-Module (MCM) Assembly

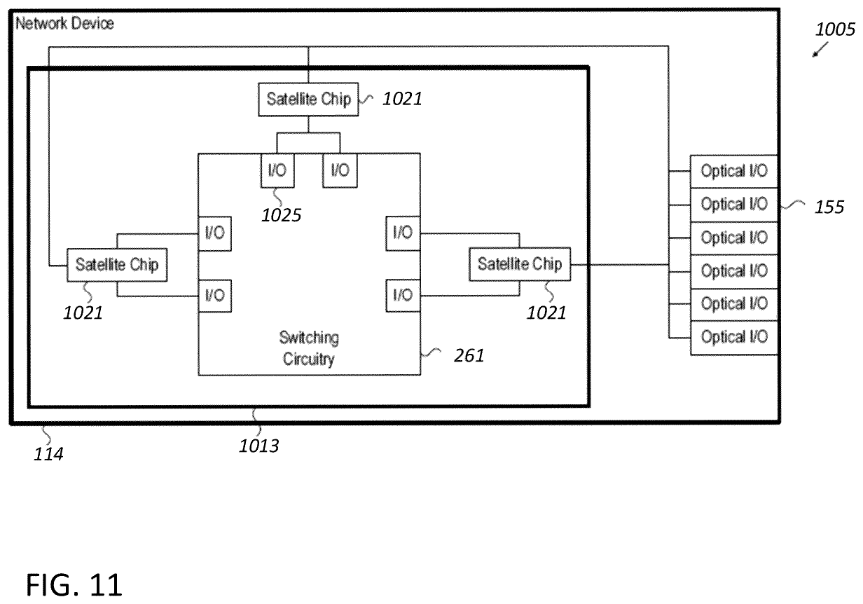

FIG. 11 is a block diagram that schematically illustrates a co-packaged Networking Device (e.g., including one or more CPO switchboards or chips) within a CPO tray 200, in accordance with an embodiment that is disclosed herein. In some embodiments, the different chips that constitute a co-packaged Networking Device are assembled on a single substrate in what is typically called the MCM assembly 1013, or alternatively, a plurality of substrates are provided in a co-packaged Networking Device within a CPO tray 200 that each support multiple chips thereon (e.g., collectively encompassing a plurality of MCM assemblies). The MCM assembly 1013 can include a switching circuitry embodying the computing resources 261 (embodying computing resources) surrounded by peripheral or satellite chips 1021. In some embodiments, the switching circuitry embodying the computing resources 261 and surrounding satellite chips 1021 are all mounted on a common substrate, although such a configuration is not required. The MCM assembly 1013 may be provided in a larger housing of the networking device, positioned behind the front panel 1005. The switching circuitry embodying the computing resources 261 may include one or more core digital Application Specific Integrated Circuits (ASICs), CPUs, GPUs, microprocessors, FPGAs, combinations thereof, and the like. The switching circuitry embodying the computing resources 261 may include a number of input ports and/or output ports. The Input/Output (I/O) ports 1025 may include electrical ports and/or optical ports. Additionally, the switching circuitry embodying the computing resources 261 may include a combination of electrical blocks and optical blocks. The electrical blocks of the switching circuitry embodying the computing resources 261 may include a number of electrical switches that are configured to route signals in an electrical domain. The optical blocks of the switching circuitry embodying the computing resources 261 may include a number of optical components that are configured to generate, detect and route signals in an optical domain. The MCM assembly 1013, in some embodiments, may concern or include multiple satellite chips 1021 that are assembled on the same substrate as the switching circuitry embodying the computing resources 261. In some embodiments, a configuration of the optical block(s) and a configuration of the electrical block(s) depends (e.g., is based on) on the number of optical ports in the I/O ports 1025.

External connectors (e.g., I/O connectors) 155, which may also be referred to as optical connectors, are placed at the front panel 1005. As mentioned above, connectivity between the MCM assembly 1013 and external connectors 155 may be transferred to the front panel 1005 through optical fibers. This connection may be made directly with an external connectors 155 of the switching circuitry or may be made with one or more of the satellite chips 1021. The connection is often made with one or more of the satellite chips 1021 because the satellite chips 1021 may include the electro-optic converters and, possibly, the SERDES to natively support the connection. The satellite chips 1021 may include one or more of aDSP processor, driver, trans-impedance amplifier, laser, modulator, photodiode, serializer-deserializer, or the like.

Some embodiments of the present disclosure are directed to a multi-chip module (MCM) with a centrally positioned main die and a plurality of peripherally positioned MCM sockets configured to mechanically receive and electrically connect mezzanine packages, which may include co-packaged optics (CPO) packages and co-packaged copper (CPC) packages. Each mezzanine package may include a package substrate including a connector portion that is configured to engage the MCM socket and a main portion extending beyond the periphery of the MCM substrate. The main portion of the mezzanine package may be configured to receive optical devices and/or integrated circuits, such as via mezzanine sockets, to allow connections to be made between the optical devices and/or integrated circuits/RF copper cable connectors and the main die of the MCM. Due to the extension of the mezzanine package beyond the periphery of the MCM substrate, the physical size of the MCM substrate may remain small to reduce cost and avoid the previously discussed production challenges, while allowing connections to a number of optical devices and integrated circuits via the mezzanine packages, which occupy the relatively inexpensive space around the periphery of the MCM substrate. As used herein, the terms “co-packaged optic” (or “CPO”) and “co-packaged copper” (or “CPC”) may refer to an advanced heterogeneous integration of either optics and silicon or copper and silicon, in which either integration may be implemented on a single packaged substrate. The CPO may utilize pluggable optical modules that include an optical engine (OE) to convert optical signals to electrical signals and electrical signals to optical signals. The CPO may further be comprised of an optical component on a photonics die and an electrical component on an electrical die.

As used herein, a ball grid array (BGA) may be a type of surface-mount packaging used for integrated circuits. BGA packages use an array of metallic conductor balls arranged in a grid to permanently mount devices such as microprocessors on a PCB. The metallic conductor balls may then undergo the reflow process described above, wherein the metallic conductor balls may be preheated, then melted to bond the IC to a substrate to form an IC package.

As used herein, the term “flip chip (FC)” may refer to a method for interconnecting dies, such as semiconductor devices, IC chips, integrated passive devices, and microelectromechanical systems (MEMS), to external circuitry with solder bumps that have been deposited onto chip pads. The solder bumps may be deposited onto chip pads on the top side of the wafer during final wafer processing. The chip may be mounted to external circuitry (such as a circuit board or another chip or wafer) by “flipping” the chip, such that the chip's top side faces down and is positioned to allow the pads of the chip to align with matching pads on the external circuit. Solder is reflowed to complete the interconnect.

### Packaging

In the packaging of integrated circuit (IC) chips, various packaging schemes are employed, including traditional two-dimensional (2D) integrated circuit (IC) packages as well as the more recently introduced 2.5D IC and 3D IC packages. In 2D IC packages, multiple chips are mounted on a printed circuit board, where high-performance logic, lower-performance logic, memory, and analog/RF functions, and other functional elements are presented as discrete devices in separate chip packages. By contrast, in 2.5D ICs and 3D IC packages, multiple IC chips are mounted on a silicon interposer instead of a conventional package substrate. The silicon interposer, which is typically a silicon wafer, allows very small and high-density conductive traces to be formed between the multiple IC chips because the fabrication processes used to form the conductive traces are the same processes used to form the metal interconnects in the metalization layers of a silicon chip.

Compared to 2.5D IC packages and 3D IC packages, a circuit board with individually packaged chips, such as a 2D IC package, has numerous disadvantages. For example, a 2D IC package is generally larger, heavier, consumes more power, and, because the signals propagate relatively slowly across the circuit board from one chip to another, is slower than an equivalent 2.5D or 3D IC package. Furthermore, a 2D IC package has more possible points of failure, given that the soldered joints on the circuit board are more likely to fail than the electrical connections formed within an interposer. That said, troubleshooting a 2D IC package after the different chips have been mounted on the circuit board is relatively straightforward. In particular, the conductive traces carrying I/O signals between the various chips on the circuit board are easily accessible and therefore can be employed to measure specific I/O signals during troubleshooting.

By contrast, troubleshooting a 2.5D or 3D IC package is far more problematic because the I/O signals transmitted between the different chips typically are embedded in the silicon interposer and are not physically accessible. Furthermore, because 2.5D and 3D IC packages are high-bandwidth and are quite dense, typically implementations can include thousands of conductive traces routed between the different chips. One example of such an implementation is a memory bus residing in between a processor and a high-bandwidth memory chip. In such implementations, even if the traces could be physically accessed through the silicon interposer with a probe, the accurate and reliable selection of a specific conductive trace or combination of conductive traces for the purpose of troubleshooting the IC package would be very difficult, if not impossible.

In at least one embodiment, one or more parallel processor(s) 3312 incorporate circuitry optimized for graphics and video processing, including, for example, video output circuitry, and constitutes a graphics processing unit (“GPU”). In at least one embodiment, one or more parallel processor(s) 3312 incorporate circuitry optimized for general purpose processing. In at least embodiment, components of computing system 3300 may be integrated with one or more other system elements on a single integrated circuit. For example, in at least one embodiment, one or more parallel processor(s) 3312, memory hub 3305, processor(s) 3302, and I/O hub 3307 can be integrated into a SoC integrated circuit. In at least one embodiment, components of computing system 3300 can be integrated into a single package to form a system in package (“SIP”) configuration. In at least one embodiment, at least a portion of components of computing system 3300 can be integrated into a multi-chip module (“MCM”), which can be interconnected with other multi-chip modules into a modular computing system. In at least one embodiment, I/O subsystem 3311 and display devices 3310B are omitted from computing system 3300.

### Shuffle Box

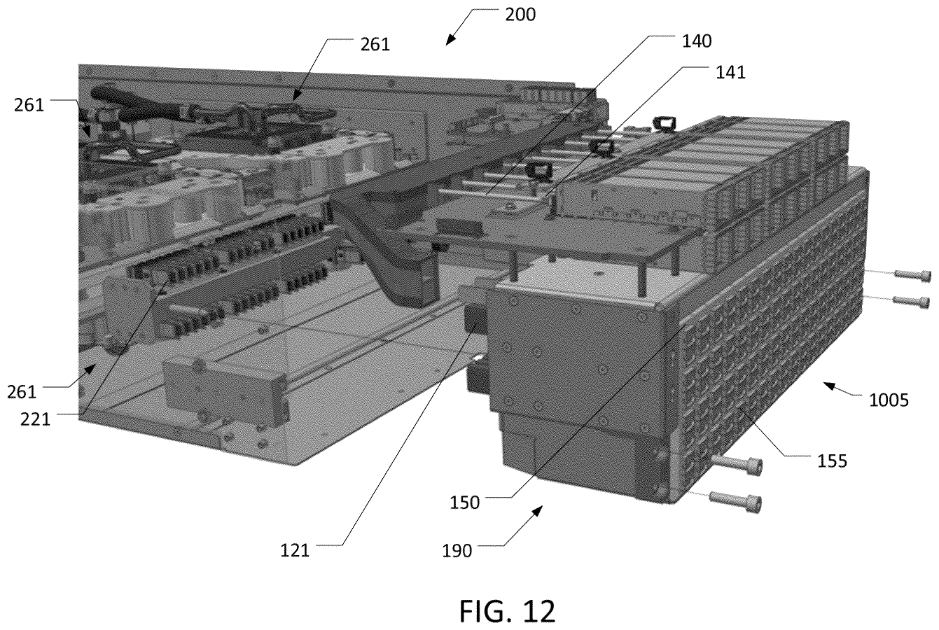

FIG. 12 shows an example optical shuffle box 190 comprising a plurality of cassettes 150 according to embodiments discussed herein. Each cassette 150 as illustrated in FIG. 12 contains an optical fiber assembly 100 as discussed herein, and is configured for shuffling connections as discussed in reference to FIGS. 5-7B. As shown, the second optical connectors 121 are positioned on a backside of the optical shuffle box 190. The optical shuffle box 190 is configured for mechanical and optical connection with a network switch within a CPO tray 200. The optical connection is provided by the plurality of second optical connectors 121 connecting with I/O connectors 221 that are in optical connection with the computing resources 261 of the network switch within the CPO tray 200 (e.g., using one or more optical cables). The external connectors 155 are in communication with the computing resources 261 when the optical shuffle box 190 is secured such that the second optical connectors 121 are optically connected with the I/O connectors 221. Specifically, each cassette 150 has a corresponding optical fiber assembly 100 that connects a plurality of first optical connectors 121 (and the optically attached external connectors 155 on the front panel of the optical shuffle box 190) with a plurality of second optical connectors 121 on a back panel of the optical shuffle box 190. The plurality of second optical connectors 121 corresponding to a single cassette 150 and positioned on the back panel of the optical shuffle box 190 are connected with a third optical connector 141 above the optical shuffle box 190. The cables 110, 120, and 140 are positioned within the optical shuffle box 190. As illustrated, a plurality of cassettes 150 may be positioned within the optical shuffle box 190, including the corresponding first optical connectors 110, second optical connectors 121, and third optical connectors 141.

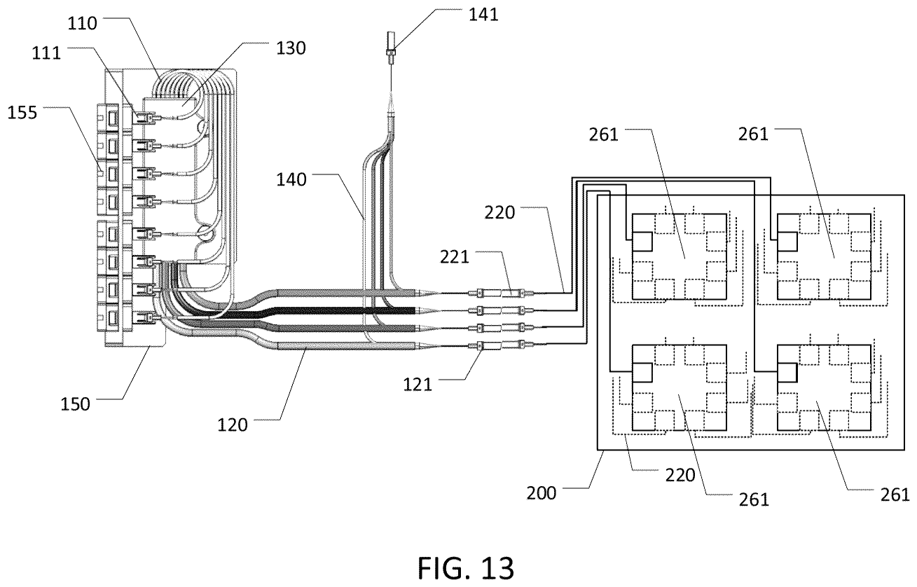

FIG. 13 illustrates connections between a single cassette 150 and a plurality of compute resources 261 of a CPO switch in a CPO tray 200. In the illustrated embodiment of FIG. 13, the illustrated cassette 150 is connected with the plurality of compute resources 261 by the second optical connectors 121 connecting with I/O connectors 221, which in turn are connected to corresponding ones of the plurality of compute resources 261 by compute cables 220 (e.g., SMF-containing cables). Only the compute cables 220 that connect with the illustrated second optical connectors 121 are shown in solid lines. The dashed lines refer to compute cables 220 connecting with unshown cassettes 150 in the same manner as shown in FIG. 13. Collectively the cassettes 150 that connect with all of the compute cables 220 (including the solid and dashed compute cables) may be secured within an optical shuffle box 190, for example, as shown in FIG. 12.

In the above description, an embodiment is an example or implementation of the disclosure. The various appearances of “one embodiment,” “an embodiment,” “certain embodiments,” or “some embodiments” do not necessarily all refer to the same embodiments. Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment. Certain embodiments of the disclosure may include features from different embodiments disclosed above, and certain embodiments may incorporate elements from other embodiments disclosed above. The disclosure of elements of the disclosure in the context of a specific embodiment is not to be taken as limiting their use in the specific embodiment alone. Furthermore, it is to be understood that the disclosure can be carried out or practiced in various ways and that the disclosure can be implemented in certain embodiments other than the ones outlined in the description above.

The disclosure is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the disclosure belongs, unless otherwise defined. While the disclosure has been described with respect to a limited number of embodiments, these should not be construed as limitations on the scope of the disclosure, but rather as exemplifications of some of the preferred embodiments. Other possible variations, modifications, and applications are also within the scope of the disclosure. Accordingly, the scope of the disclosure should not be limited by what has thus far been described, but by the appended claims and their legal equivalents.

1. An optical fiber assembly comprising:
a plurality of first optical fibers of a first fiber type connecting one or more first connectors to one or more second connectors; and
a plurality of second optical fibers of a second fiber type connecting one or more second connectors with one or more third connectors.

2. The optical fiber assembly of claim 1, wherein:
the plurality of first optical fibers terminate at pins in the one or more first connectors and terminate at pins in the one or more second connectors; and
the plurality of second optical fibers terminate at pins in the one or more second connectors and at pins in the one or more third connectors.

3. The optical fiber assembly of claim 1, wherein:
the plurality of first optical fibers are single mode fibers (SMFs); and
the plurality of second optical fibers are polarization maintaining fibers (PMFs).

4. The optical fiber assembly of claim 1, wherein each of the one or more second optical connectors contains a portion of each of the plurality of first optical fibers and a portion of each of the plurality of second optical fibers.

5. The optical fiber assembly of claim 1, wherein:
the one or more first optical connectors comprises a first quantity of first optical connectors;
the one or more second optical connectors comprises a second quantity of second optical connectors; and
the one or more third optical connectors comprises a third quantity of third optical connectors.

6. An optical fiber assembly comprising:
a plurality of first connectors each having a first plurality of optical channels;
a plurality of second connectors for connection with a Co-Packaged Optics (CPO) switch, each having a second plurality of optical channels;
a plurality of optical fibers each terminating in one of the plurality of first connectors and one of the plurality of second connectors;
wherein each of the plurality of first connectors terminates x optical fibers in the first plurality of optical channels, wherein the x optical fibers collectively connect each of the plurality of first connectors with all of the plurality of second connectors;
wherein each of the plurality of second connectors terminates at least 2x optical fibers in the second plurality of optical channels, wherein the at least 2x optical fibers collectively connect each of the plurality of second connectors with all of the plurality of first connectors.

7. The optical fiber assembly of claim 6, wherein:
the first plurality of optical channels is 12 optical channels; and
the second plurality of optical channels is 24 optical channels.

8. The optical fiber assembly of claim 6, wherein x is 8 and wherein at least 2x is 18.

9. The optical fiber assembly of claim 6, wherein the x optical fibers terminating in each of the plurality of first connectors are bundled in a plurality of first bundles.

10. The optical fiber assembly of claim 9, wherein the 2x optical fibers terminating in each of the plurality of second connectors are bundled in a plurality of second bundles.

11. The optical fiber assembly of claim 10, further comprising a fanout box, and wherein optical fibers are shuffled between the plurality of first bundles on a first end of the fanout box and the plurality of second bundles on a second end of the fanout box.

12. The optical fiber assembly of claim 6, further comprising:
at least one external laser connector;
a plurality of tertiary optical fibers each terminating in one of the plurality of second connectors and one of the plurality of external laser connectors.

13. The optical fiber assembly of claim 12, wherein:
each of the plurality of optical fibers are a first fiber type; and
each of the plurality of tertiary optical fibers are a second fiber type.

14. The optical fiber assembly of claim 12, wherein:
each of the plurality of optical fibers are single mode fibers (SMFs); and
each of the plurality of tertiary optical fibers are polarization maintaining fibers (PMFs).

15. An optical fiber assembly comprising:
a plurality of first optical cables for connection with a Co-Packaged Optics (CPO) switch;
a plurality of second optical cables;
a plurality of optical channels within the first optical cables and the second optical cables to optically connect the plurality of first optical cables with the plurality of second optical cables; and
wherein each of the plurality of first fibers is optically connected with all of the plurality of second fibers by respective optical channels of the plurality of optical channels.

16. An optical fiber assembly comprising:
a plurality of first optical cables extending from the optical fiber assembly; and
a plurality of second optical cables extending from the optical fiber assembly;
wherein the optical fiber assembly optically connects the plurality of first optical cables with the plurality of second optical cables.

17. The optical fiber assembly of claim 16, wherein:
the plurality of first fiber optical cables comprise a plurality of fibers;
the plurality of second optical cables each comprise a plurality of fibers; and
wherein the optical fiber assembly further comprises a fanout box shuffling the plurality of fibers from the plurality of first optical cables to the plurality of second optical cables.

18. The optical fiber assembly of claim 16, wherein the optical fiber assembly comprises twice as many second optical cables as first optical cables.

19. The optical fiber assembly of claim 17, wherein each of the plurality of first optical cables comprises twice as many fibers as each of the plurality of second optical cables.

20. The optical fiber assembly of claim 17, wherein each of the plurality of first optical cables is connected with all of the plurality of second optical cables.

21. The optical fiber assembly of claim 17, wherein the first optical cables have a first connector type and the second optical fibers have a second connector type.

22. The optical fiber assembly of claim 21, further comprising a plurality of tertiary optical cables extending from the second connector type, wherein the plurality of tertiary optical cables comprise optical fibers of a different fiber type than the first optical cables and second optical cables.

23. An optical shuffle box comprising:
the optical fiber assembly of claim 15;
a housing containing the optical fiber assembly;
a plurality of external connectors connected with the first fibers, wherein the plurality of optical connectors are positioned on a front side of the housing and occupy greater than 50% of an area defined by the front side of the housing.

24. The optical shuffle box of claim 23, wherein the plurality of external connectors are Multi-Fiber Push On (MPO) connectors.

25. The optical shuffle box of claim 23, wherein the plurality of external connectors comprises 8 external connectors.

26. A method of transmitting an optical signal, the method comprising:
transmitting an optical signal into a first optical fiber in a connector comprising a first plurality of optical fibers;
routing the optical signal along the first optical fiber into a second connector comprising a second plurality of optical fibers;
wherein the second plurality of optical fibers is a different quantity than the first plurality of optical fibers.
